(19) United States
(12) Patent Application Publication
(10) Pub. No.: US 2009/0164345 A1
(43) Pub. Date: Jun. 25, 2009

(54) System and method for management and control of containerized freight

(75) Inventors: Sean Richard Pierce, Seattle, WA (US); Sharon A. Alper, Seattle, WA (US); Robert Michael Ahern, El Paicala (PA); Gregory J. Cook, Bainbridge Island, WA (US); Hans Henrik Rikhof, Seattle, WA (US); Donald H. Taylor, Seattle, WA (US)

Correspondence Address: DORSEY & WHITNEY LLP;INTELLECTUAL PROPERTY DEPARTMENT, SUITE 3400, 1420 FIFTH AVENUE, SEATTLE, WA, 98101, US

(73) Assignee: Tideworks Technology, Inc., Seattle, WA (US)

(21) Appl. No.: 12/004,741

(22) Filed: Dec. 21, 2007

(51) Int. Cl. G06F 19/00; G05B 13/04

(52) U.S. Cl. 705/29; 700/29

(57) ABSTRACT

A system and method for managing containerized freight is disclosed. The system generates a 3-D view of a containerized freight terminal that is rendered on a display. The 3-D view includes rendered scale models of all the containers, vessels, buildings and equipment within the freight yard and according to stored information relating to such. The rendered 3-D view is updated as changes are made to the stored information and according to user input related to the desired point of view and perspective. The rendered scale models may be selectively visually coded or displayed according to pre-determined criteria.

### TECHNICAL FIELD

Embodiments of this invention relate to systems and methods for managing and controlling containerized freight, and, more particularly to an integrated vessel, rail, yard and equipment information and control system.

### BACKGROUND OF THE INVENTION

Containerization of freight for intermodal transport has revolutionized the shipping industry. Containerization is a system of freight transport that uses standard ISO containers that may be filled with freight, sealed, and then loaded on and off of various transport vehicles such as container ships, railroad cars, planes and trucks. Since worldwide adoption of the ISO standards for shipping containers, the containerized freight industry has grown tremendously. Today, it is estimated that approximately 90% of the world's non-bulk cargo is moved in shipping containers.

Containerized cargo typically moves through a shipping terminal or intermodal transport facility. Such facilities are responsible for receiving containers from one or more vessels or vehicles and then transferring the containers onto one or more other vehicles for further transport. Such a shipping terminal may, for example, be equipped to unload containers from a seagoing container ship and load the containers onto a freight train for further transport to an inland location. Alternatively, the containers may be loaded onto trucks or even other seagoing vessels. Likewise, containers may be shipped to the terminal via ground transportation and then loaded onto a vessel for transport overseas.

As the use of containers has become prevalent, shipping terminal operators have felt an increased need for, and reliance on, logistics tools for tracking and managing the containers as they pass through the terminal. A typical shipping terminal may be responsible for tracking and managing many thousands of containers on numerous vessels, trains and vehicles. Terminal managers, container yard planners and operations personnel must constantly work to plan, execute, monitor and revise numerous tasks in order to move vessels and vehicles through as quickly as possible. Conventional logistics tools are generally built on one or more databases that may contain information about all the containers, equipment, vessels, vehicles, moves, work queues and the like. Such tools allow terminal personnel to track and manage these items through a textual view of the underlying database objects that represent each of these entities. In some cases, and especially with smaller terminals, such tools are adequate.

FIG. 1 illustrates a conventional logistics tool with a textual view 100. The textual view 100 of container information includes an equipment list 110 and an equipment move list 120. The equipment list 110 shows a list of the various pieces of equipment that may be in the terminal and the equipment move table 120 shows the moves assigned to a piece of equipment selected in the equipment list 110. In FIG. 1, a piece of container handling equipment, side pick 155, is denoted by the label SP11 and is shown selected in the equipment list 110. As a result of the side pick 155 being selected in the equipment list 110, the move list 120 shows a list of moves 130, 140 and 150 assigned to the side pick 155. For example, the move list 120 shows that the move 130 is related to container number GESU4838260, which is located at the yard coordinates D503 D3. Other information about the assigned moves such as the destination of the move may also be displayed. By navigating through lists of this variety, operations personnel may infer information about the state of the yard, status of equipment and the containers, and the movement of containers within the yard. Although operations personnel can see these assigned moves in the move list 120, there is no way of knowing from the information provided by the equipment list 110 or the move list 120 where the side pick 155 is physically located in relation to the moves 130-150, or where the moves 130-150 are located in relation to each other.

Conventional list-based logistics tools, such as that previously described with reference to FIG. 1, fail to provide several desirable features because information about, for example, the relative positions of equipment and containers is not provided. A shipping terminal is a very physical business that operates in three dimensions. A problem with conventional tools is they do not display adequate spatial information about the containers, equipment, vessels and the like. The list-based tool does not provide context for yard features, including light poles, reefer walkways, buildings, or other features that would block access to or impede movement of equipment or containers through a particular area of the yard. Additionally, containers being stored in the yard of the terminal are generally stacked. The spatial location of a given container cannot, therefore, be adequately viewed by conventional tools since these tools will typically display only a textual list of the containers in any given stack. The stack location, however, cannot be discerned visually. Likewise, although the physical location of equipment may in some instances be available in the form of GPS coordinates or the like, the physical location of that equipment relative to other pieces of equipment, containers and vessels cannot be easily discerned. Terminals using such conventional logistics tools are forced to use other means for gaining the proper physical context and state of the yard and its contents. This is typically done through the use of numerous yard supervision personnel, constant radio contact between equipment operators and supervision, and/or visual inspections of the yard. This process is an inefficient use of terminal resources because many people are required for proper traffic control. Likewise, conventional tools are not necessarily integrated with one another and may feature little or no interoperability.

There is therefore a need for a terminal management system that provides three-dimensional (3-D) context for terminal objects and provides management and control of container, equipment, vessel, and vehicle traffic into and out of the terminal.

### BRIEF DESCRIPTION OF THE DRAWINGS

FIG. 1 illustrates a conventional containerized freight logistics tool.

FIG. 2 is a simplified block diagram of a system for managing containerized freight according to an embodiment of the invention.

FIG. 3 is a 3-D rendering of a freight terminal according to one embodiment of the invention.

FIG. 4 is a zoomed view of the freight terminal of FIG. 3.

FIG. 5 is a color-by view of a freight terminal yard according to one embodiment of the invention.

FIG. 6 is a zoomed color-by view according to one embodiment of the invention.

FIG. 7 is an alternative color-by view of the containers illustrated in FIG. 6.

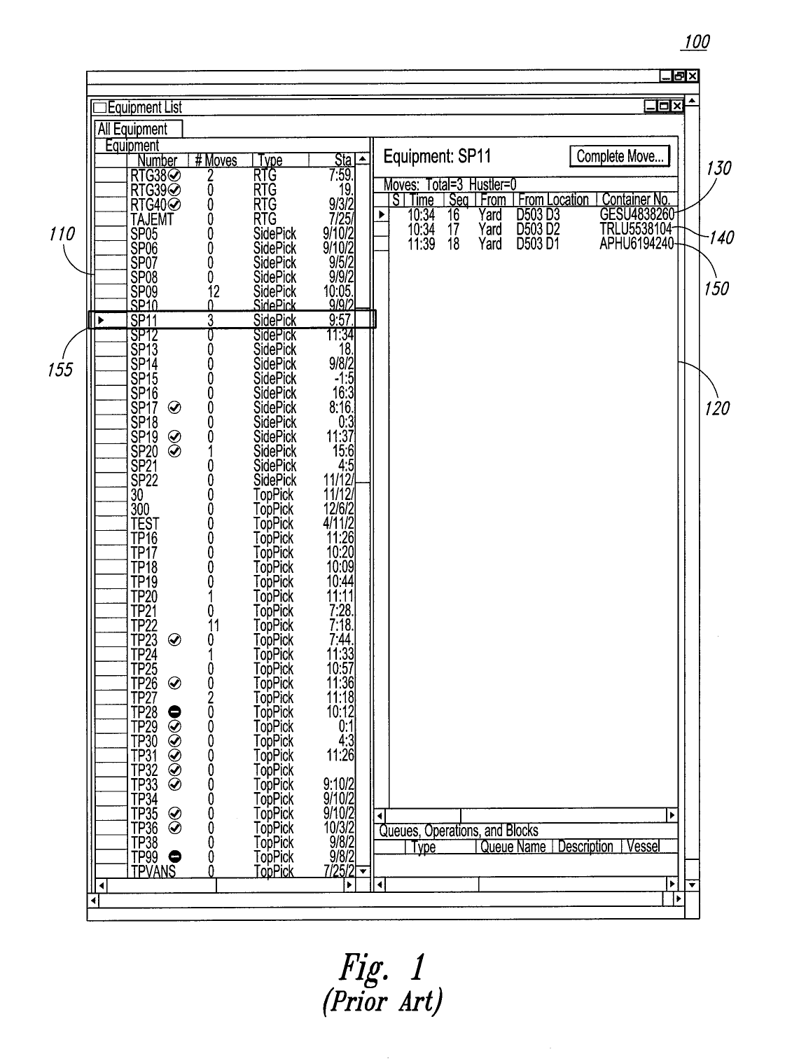

### DETAILED DESCRIPTION OF EMBODIMENTS OF THE INVENTION

Certain details are set forth below to provide a sufficient understanding of embodiments of the invention. However, it will be clear to one skilled in the art that embodiments of the invention may be practiced without these particular details. Moreover, the particular embodiments of the present invention described herein are provided by way of example and should not be used to limit the scope of the invention to these particular embodiments. In other instances, well-known circuits, control signals, timing protocols, and software operations have not been shown in detail in order to avoid unnecessarily obscuring the invention.

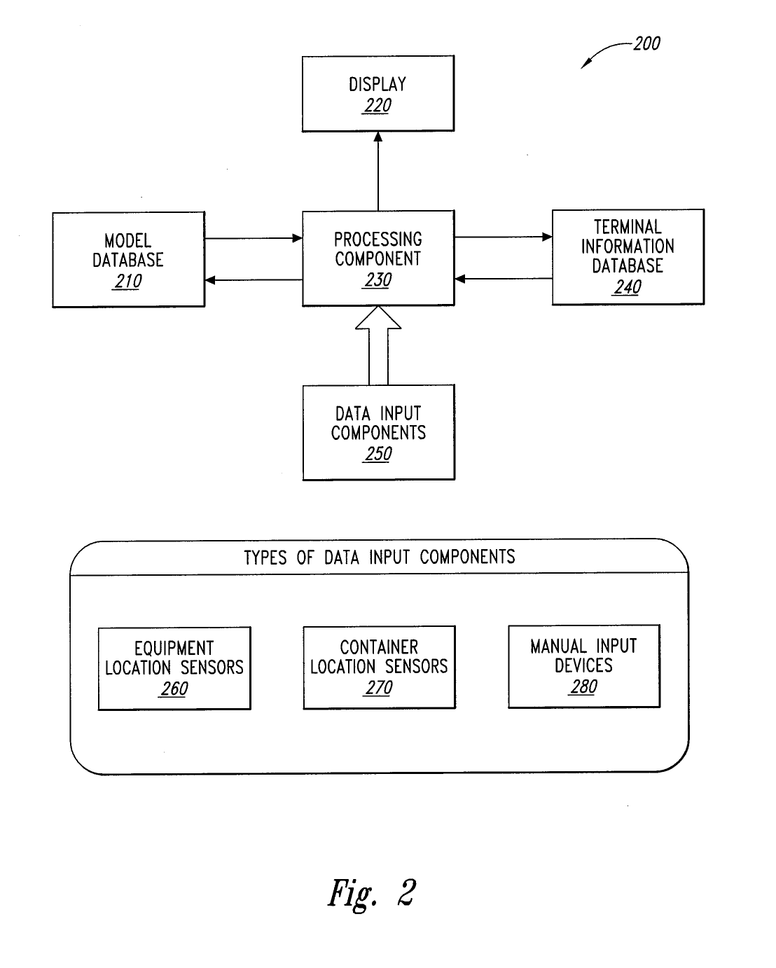

FIG. 2 illustrates a block diagram of a system 200 according to an embodiment of the invention for providing a 3-D view of a freight terminal and for managing containers and equipment therein. The system 200 includes a processing component 230. The processing component may comprise any of a variety of different processors or computers suitably programmed to permit management of containerized freight and further programmed to render a 3-D view of a freight terminal and the interrelatedness of the various terminal objects, such as containers, equipment, and structures.

The processing component 230 may be connected to a model database 210 and a terminal information database 240. The model database 210 may contain models and other information necessary to render a 3-D view of a freight terminal. Such models and information are used by the processing component 230 to render and display the 3-D view on the display 230. The terminal information database 240 may contain information related to containers present in a freight terminal yard, or containers present on vessels, trains or trucks located at the freight terminal 200. For example, information about the destination vessel of a particular container or the equipment assigned to move that container may be stored in the terminal information database 240 for a particularized rendering of the containers within the 3-D view, as is discussed more fully below.

The system 200 also includes data input components 250. Data input via the components 250 may be used by the processing components to update either the model database 210, the terminal information database 240, or both. The data input components 250 may comprise equipment location sensors 260, container location sensors 270 or manual input devices 280 such as a keyboard and mouse. The processing component 230 may use location information provided by the equipment location sensors 260 to render and display a 3-D rendering of such equipment on the display 230 wherein the rendering places the equipment in its physically correct position within the virtual 3-D view of the freight terminal. The processing component 230 may do likewise with respect to containers in a freight terminal using position information provided by the container location sensors 270.

In addition to rendering the 3-D view of a freight terminal, the system 200 may provide information about each container, vessel, berth or any other terminal objects rendered in the 3-D view. For example, a significant amount of information about each vessel may be made available by, as is discussed below, some suitable means of querying the vessel information. This information might include, for example, the vessel's estimated time of departure, the percent of the containers to be loaded or unloaded that is complete, the total number of containers to be loaded or unloaded, the total number of containers that must be re-handled during loading or unloading, the date or time that the first or last container is loaded or unloaded, the estimated time of completion, any required time of completion, or the total number of moves. This information may be accessed in a number of ways. In one embodiment, double-clicking the vessel with a pointer such as a mouse pointer could cause a dialog to be displayed containing some or all of the available vessel information. Alternatively, simply hovering such a pointer over the vessel for a pre-determined period of time could likewise cause some or all of the available vessel information to be displayed.

The system 200 further provides information about the relationship of terminal objects rendered in the 3-D view through the use of visual coding, such as color coding, or displaying only the terminal objects having a particular relationship. The visual coding or selective display of terminal objects can be used to correlate projected moves, spatial data, vessel production statistics, move state and equipment assignment details to communicate to users how terminal resources relate to work requirements and the physical characteristics of the terminal. For example, users can color code containers by vessel assignment, yard assignment, equipment assignment, or queue assignment. As a result, the user can easily identify which lifting equipment has a container on a work list, or the yard queue to which the container belongs. Users can color the yard by equipment or queues. The ability to color the yard allows planners to see the yard coverage resulting from equipment or queue assignments and adjust accordingly. The spatial context provided by the system 200 can enable planners to more appropriately plan and assign moves that make sense in the context of the yard.

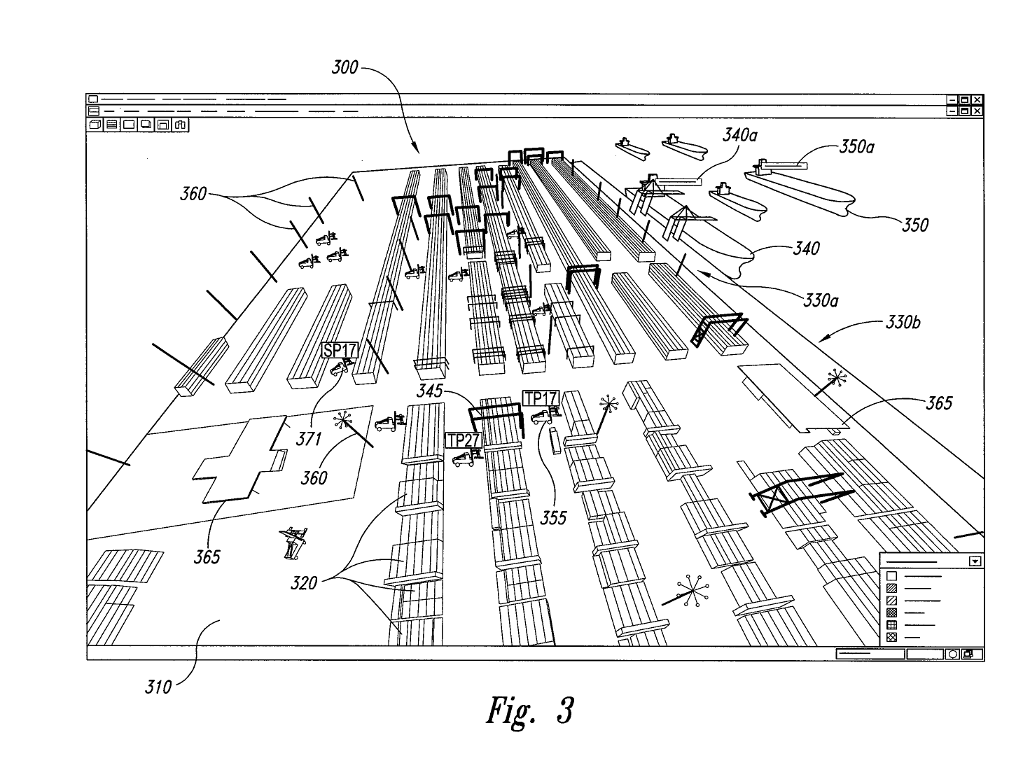

FIG. 3 illustrates a 3-D rendering generated by the system 200 of a freight terminal 300 according to one embodiment of the invention. The freight terminal 300 is rendered and displayed based on scale 3-D models of containers, vessels, structures, equipment and other terminal objects in the freight terminal 300 view. The 3-D models of the terminal objects may be created with any of a number of common 3-D modeling software tools as will be understood by one of ordinary skill. The model for the freight terminal 300 is typically coded from the actual terminal blueprints to ensure everything renders to scale. Once the models are created, the models and other information related to their rendering, such as, for example, their physical dimensions, a set of vertices that delineate their boundaries, location within the scene or texture maps, may be stored in any number of different locations. These models could be stored, for example, as flat files on a disk or in a database of some type. In the embodiment of the system 200 shown in FIG. 2, the models and other information related to rendering the freight terminal 300 are stored in the model database 210. As was discussed above, a database is typically created and used to store terminal information about, for example, all the containers in the yard. In one embodiment, each database used to store the rendering information and the terminal information about the containers, or other terminal objects of the freight terminal, may be different databases. Alternatively, the rendering and terminal information may be stored in the same database.

As was discussed above, a set of vertices within a model may be used to delineate the physical boundaries of any particular terminal object. The same may be true of the freight terminal 300. The set of vertices that delineate the freight terminal 300 may also delineate other sub-regions within the freight terminal 300. In particular, the example freight terminal 300 as shown in FIG. 3 may contain a sub-region called the yard 310. The freight terminal 300 is illustrated with only a single yard but may contain more than one yard. The yard 310 is typically used for temporary storage of freight containers 320. The freight terminal 300 also may include one or more berths 330a and 330b. In some cases, such berths may be empty (i.e. contain no vessel) as illustrated by berth 330b. A berth may also be displayed with a vessel 340 docked in the berth as illustrated by berth 330a. A berth may also be displayed with more than one vessel floating parallel to the berth to indicate vessels that have not yet arrived, but that are scheduled to arrive at a later time, such as within a week.

The yard 310 contains a number of different terminal objects, each of which may be displayed in the 3-D rendering of the freight terminal 300. In particular, the yard typically includes containers in various states, structures and terminal blocks. The different terminal objects may be displayed by the system in a number of different ways. The system can simply display all the containers in the yard or, alternatively, and as will be discussed in more detail below, the system 200 can display terminal objects with visual coding, such as color coding, or display only particular terminal objects to represent different relationships between the terminal objects. For example, the 3-D rendering of the terminal 200 may included those containers that are planned for a move. Likewise, the system 200 may display all activated containers. That is, containers that have been dispatched, are in transit, or are otherwise active within the yard. In addition to containers, the yard may contain a number of different structures. For example, reefer stations, antennas, buildings, fire hydrants and other structures may be displayed. For example, the freight terminal 300 contains light poles 360 and buildings 365. A yard may also contain a number of types of storage and staging areas, each of which will be displayed by the system. Storage and staging areas might include rubber-tired gantry (RTG) crane blocks, rail-mounted gantry cranes (RMG's), container heaps, chassis storage areas, railtracks, straddle carrier and top lift container stacks, and other types of storage areas.

As is known, a berth is a specific area within the freight terminal where a vessel may be moored. Each berth will typically be labeled alpha-numerically and any vessel present in the berth will be displayed in its actual physical position within the berth. That is, the vessel house will face the correct direction and any vessel ID that is present on the vessel will likewise be displayed. The 3-D rendering of the freight terminal 300 includes examples of such vessels 340 and 350. Above each vessel is a vessel label 340a and 350a that denotes the name of each vessel. In addition to yard and berth objects, the 3-D rendering of the freight terminal 300 may also include terminal equipment objects. Operations personnel and dispatchers must know where equipment is physically located in order to more efficiently assign container moves and respond to changes in the operation of the freight terminal 300 due to, for example, equipment breakdown. Virtually any type of equipment may be rendered and tracked within the system including: RTGs, RMGs, straddle carriers, hustlers, top picks, side picks, or ship to shore cranes. The freight terminal 300 illustrates several examples of such equipment. The freight terminal 300 may include, for example, a top pick 355, an RTG 345 or a side pick 371.

In an embodiment, all yard, berth and equipment terminal objects may be rendered to scale within the 3-D freight terminal view. Likewise, the physical location of such terminal objects may be determined by, for example, a GPS or other locating system, and wirelessly relayed to the system. This location information is then used by the system 200 to display the terminal objects in the 3-D view and update their position in real time. In another embodiment, the location of terminal objects is periodically manually entered into the system and the 3-D view of the freight terminal can be updated to reflect the last known position of the terminal objects. The location of the terminal objects may be specified by entering the coordinates for the terminal objects. As previously discussed with reference to the system 200, the processing component 230 may use location information provided by the equipment location sensors 260 to render and display a 3-D rendering with the equipment in its physically correct position within the virtual 3-D view of the freight terminal. The processing component 230 may do likewise with respect to containers in the freight terminal 300 using position information provided by the container location sensors 270.

Numerous types of terminal objects and equipment may be displayed within the freight terminal 300. These may include, for example: containers, vessels, top picks, side picks, quay cranes, rail-mounted gantry cranes (RMGs), rubber-tired gantry cranes (RTGs), hustlers, and straddle carriers. A top pick is a type of container handling equipment, very similar to a large capacity forklift, with a specialized spreader bar attachment used for locking on to containers. A top pick may be used for handling both laden and empty containers. A side pick is a type of container handling equipment, very similar to a forklift, with a specialized attachment used for locking on to containers. A side pick, however, has less lifting capacity than a top pick and, therefore, may be used for handling empty containers only. Quay cranes are cranes located on the wharf or quay next to a berth and designed for loading and unloading laden and empty containers to and from the vessel in the berth. A rubber-tired gantry crane (RTG) is a crane located within the yard and designed to move containers to or from the container stacks in the yard, or to or from trucks. RTGs straddle the entirety of the container stacks, which may vary in height and width. A rail-mounted gantry crane (RMG) is very similar to the RTG except that instead of being rubber-tired, the gantry crane is on rails. Hustlers are terminal trucks that may be used to move containers from location to location within the freight terminal itself, e.g. either to and from the vessel or to and from some other location on the terminal. Hustlers are generally equipped with a catch chassis for receiving and carrying a container. A straddle carrier is another type of container handling equipment used for an alternative mode of operation and terminal layout. In a suitably designed terminal, a straddle carrier may do both the job of hoisting the container, like an RTG or a top pick, and the job of transporting the container to another location within the terminal, like a hustler. In every case, embodiments of the invention and the example equipment discussed above may be used in conjunction with geographical location systems to provide accurate and real-time location and path information about the equipment and for updating the 3-D rendering of the equipment in the freight terminal 300. In another embodiment, the processing component 230 may accept input from the input components 250 to facilitate rapid processing of certain tasks. For example, an embodiment may allow the user to “drag-and-drop” a selected block of containers onto a yard queue associated with a container handling equipment, such as a top pick, thereby adding such containers to be moved by that equipment. In this fashion, containers may be rapidly and visually allocated to associated equipment for handling.

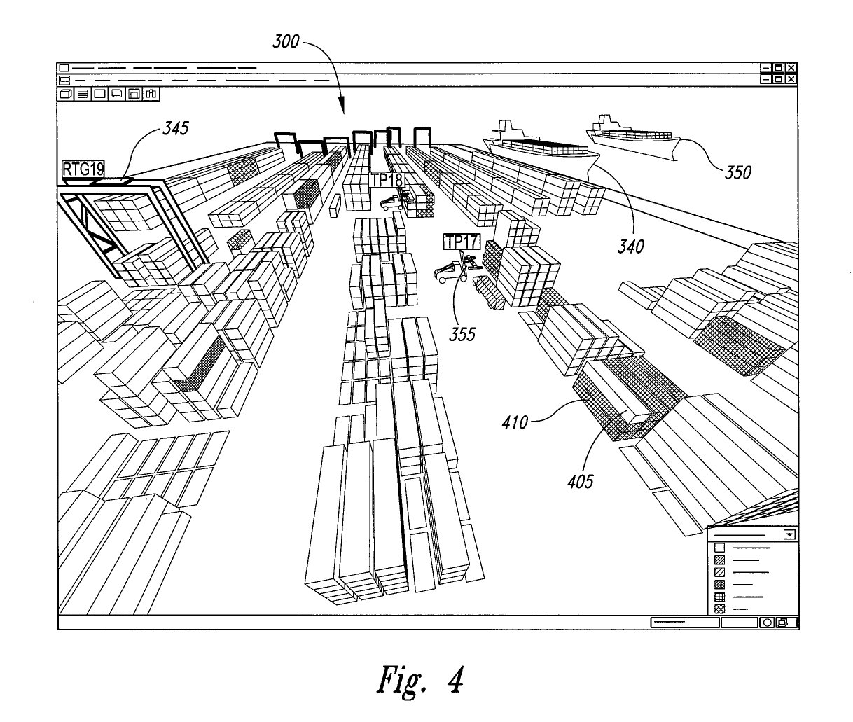

The 3-D view of the freight terminal as described above brings numerous benefits to freight terminal managers and personnel. The 3-D view allows the terminal manager to quickly and easily obtain a high-level view of terminal operations. The 3-D view helps provide an early warning of potential issues involving equipment assignment and move planning. Real-time or near real-time 3-D views of inactive equipment allow managers to more quickly react to equipment breakdowns and to more accurately assess equipment idle time. For example, excess equipment idle time may permit a terminal manager to monitor productivity and reallocate resources to improve terminal efficiency. Such a 3-D view also facilitates remote management of the terminal and its workforce. In an embodiment, the processing component 230 may accept input from the input components 250 that cause the 3-D view of the freight terminal to be re-rendered with a new point of view or with a different zoom level. The freight terminal can be viewed from various different perspectives, including the ability to “fly through” the terminal. As previously discussed, having the freedom to choose a vantage point of the 3-D view of the freight terminal allows a terminal manager to quickly assess the status of terminal operations and further identify locations in the freight terminal that may need attention. FIGS. 3 and 4 are examples of re-rendering that reflects differences in both the point of view and the zoom level. The rendering of the freight terminal shown in FIG. 3 is from a steeper angle than that of FIG. 4 and thus is looking at a more top down angle. FIG. 4, on the other hand, is more from a side perspective. Likewise, the rendering of FIG. 4 is from a closer vantage point to the freight terminal as can be appreciated by the larger size of the top-pick 355.

FIG. 4 illustrates a zoomed view of the freight terminal 300 of FIG. 3. The zoomed view of the freight terminal 300 shows portions of the yard 310 with greater detail and spatial context. For example, the RTG 345, the top pick 355 and vessels 340 and 350 are visible in this zoomed view of the freight terminal 300. The zoomed view, however, more readily provides certain information because it allows operations personnel to more easily view the spatial context of that location within the yard. For example, it can more readily be discerned that the container 405 has a different status than the other containers in its stack. This is apparent because the container 405 has a different color than, for example, the container 410 within the same stack. Operations personnel using embodiments of the invention can control the coloration of the containers within the freight terminal 300 view by applying various color-by criteria as is discussed more fully below. Also, the scale rendering of objects within the freight terminal 300 view may permit operations personnel to identify physical bottlenecks in the yard 310. If, for example, a top pick was in the process of lifting the container 405, operations personnel would see the top pick in this zoomed view more readily. The operations personnel could, therefore, avoid dispatching another top pick or RTG to move container 410 since the newly dispatched top pick wouldn't be able to get to the container 410 until the container 405 move had been completed.

In one embodiment, the system 200 may permit the freight containers 320 of FIG. 3 to be color-coded to convey various types of additional information. For example, the containers 320 may be color coded according to vessel ID, train ID, container or yard-to-yard move attributes. Vessel ID attributes may be used to color-code containers according to whether the container is planned or activated with respect to a particular vessel. For example, the user may assign a particular color to all the containers that are to be loaded or unloaded from a particular vessel. Likewise, such containers that have been activated and are in the process of being loaded or unloaded may be assigned a color. In one embodiment, the system can project vessel moves for a given day or time range and color code the projected container moves. Such container moves may be of several types. For example, container moves that are from yard-to-yard, to or from vessels, to or from trains, or to and from trucks. Such a system may also render a view of what the terminal would look like in the future based on information in the terminal information database 240, for example, preplanned move information, terminal throughput information, equipment and personnel information, and move rates. Move rates may be based on a predetermined rate set by operations personnel, pre-computed move plans, historical move data, or a combination thereof. Historical data may be based on historical data for one or more pieces of equipment, a particular equipment operator or a particular vessel. The “look ahead” feature allows terminal managers to determine the future status of terminal operations before events take place and provides an opportunity to modify the deployment of terminal resources to meet productivity goals.

The previously discussed color coding options exist with regard to a particular train ID. Container and yard-to-yard move attributes may be used to color code containers according to current and future transactions based on the destination or origin of a set of containers.

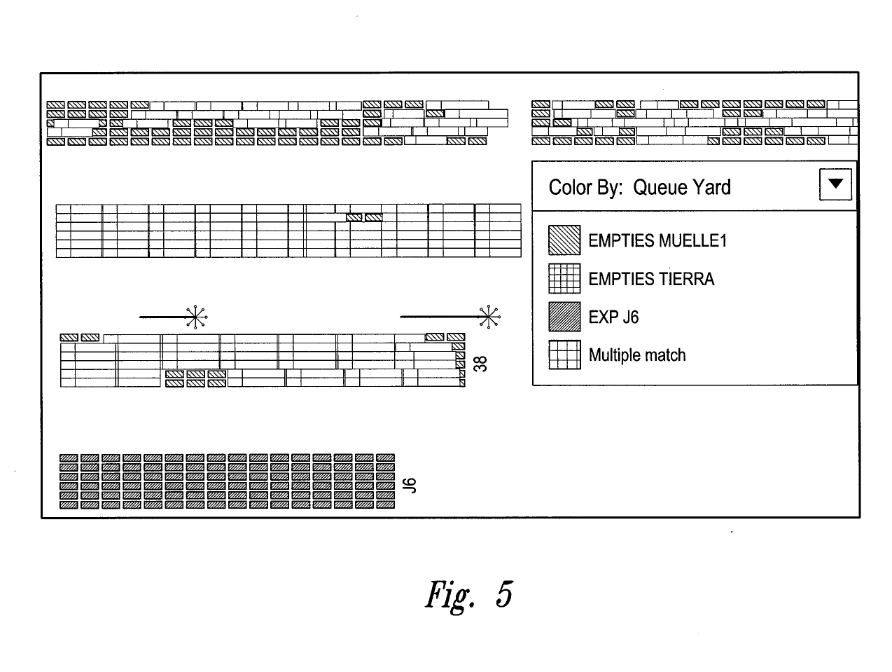

In an embodiment, the system 200 may permit the yard blocks within the freight terminal 300 to be colored based on equipment or queues. For example, blocks may be colored based on their queue assignment, as shown in FIG. 5. Yard blocks 510-513 are similarly color coded to indicate the yard blocks are reserved for and associated with empty containers. Yard block 520, in contrast, is color coded differently from yard blocks 510-513, and FIG. 5 indicates that it is associated with expected export containers. When applying the “color-by” view to equipment, a particular color may be specified for each yard block based on the equipment to which it is assigned.

In another embodiment, the system may permit users to toggle the rendering and display of certain features in accordance with certain yard management goals. For example, the user may toggle between a 2-D and 3-D rendering of the freight terminal 300. A set of Show/Hide toggles may be provided that permit the user to control whether certain aspects of the freight terminal 300 are visible in the current 3-D view. For example, the user may Show/Hide containers without moves (i.e. inventory containers). The user may also Show/Hide according to row number which toggles the display of entire rows. Both inactive and active equipment may be toggled from view with a suitable toggle. Also, fixed yard features such as light posts, buildings, reefer walkways, and the like, may be displayed or hidden with a suitable Show/Hide toggle.

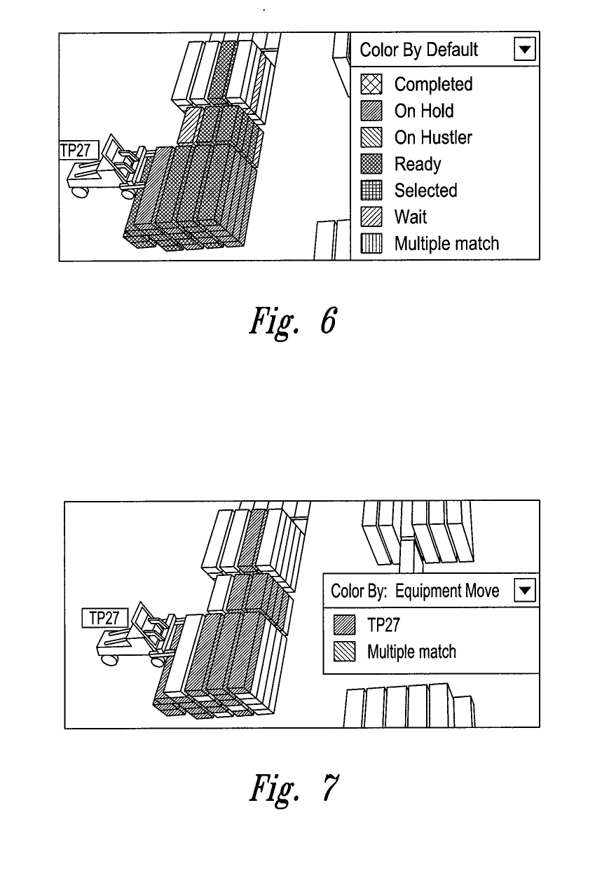

FIG. 6 illustrates an example color-by view of the freight terminal 300 according to another embodiment of the system 200. The color-by feature provided by the system 200 can also be applied to containers 320. The containers in FIG. 6 are color-coded by move status. For example, containers may be colored based on whether they are Completed, On Hold, On Hustler, Ready, Selected or Waiting. A container that is Completed is in its final location. A container that is On Hustler is physically on the chassis of the yard truck for delivery to another point in the freight terminal 300. Similarly, containers that are On Hold or Ready are either inactive due to a hold or activated and able to be moved, respectively. Waiting containers are those containers that have scheduled moves but such moves are currently inactive and must be activated before the moves can be executed.

FIG. 7 is an alternative color-by view of the same 3-D view as that of FIG. 6 according to an embodiment of the system 200. In this example, the system 200 generates a color-by view having containers colored by assigned lifting equipment instead of colored by move status illustrated in FIG. 6. In particular, the containers that are to be moved by the top-pick TP27 705 are colored according to the color legend 710.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A computer implemented method for managing freight, the method comprising:
creating a terminal database containing information related to objects in a freight terminal;
displaying a 3-D rendering of the freight terminal that reflects the spatial relationships between the objects in the freight terminal based on the information in the terminal database and wherein the objects displayed in the rendering of the freight terminal are interactive; and
updating and re-displaying the 3-D rendering of the freight terminal.

2. The method of claim 1 further comprising creating a report based on information in the terminal database.

3. The method of claim 2 wherein the report is related to at least one of the following: the location of one or more containers based on search criteria, the location of one or more pieces of equipment in the freight terminal, and an estimate of the time remaining to complete a task or set of tasks.

4. The method of claim 3 wherein search criteria comprises information related to at least one of: the inclusion of the one or more containers in a queue of containers to be moved, the physical proximity of the one or more containers to a predetermined location, the destination location of the one or more containers, a vessel ID, and a train ID.

5. The method of claim 4 wherein a queue of containers to be moved comprises a queue of containers to be moved that are grouped according to at least one of: handling equipment assigned to move the containers, the destination location of the containers to be moved and the source location of the containers to be moved.

6. The method of claim 5 wherein the destination location of the containers to be moved comprises at least one of: a yard location, a vessel, a train and a truck.

7. The method of claim 5 wherein the source location of the containers to be moved comprises at least one of: a yard location, a vessel, a train and a truck.

8. The method of claim 5 wherein objects in the freight terminal include at least one of: one or more containers, one or more stacks of containers, one or more vessels, one or more trains, one or more trucks, and handling equipment for moving containers.

9. The method of claim 8 wherein handling equipment comprises at least one of: ship-to-shore cranes, quay cranes, straddle carriers, rail-mounted gantry cranes, rubber-tired gantry cranes, side-picks, top-picks, forklifts, hustlers and chassis.

10. The method of claim 1 wherein updating and re-displaying the 3-D rendering of the freight terminal comprises updating and re-displaying the 3-D rendering of the freight terminal according to updates to the terminal database.

11. The method of claim 10 wherein updates to the terminal database comprise at least one of updates that include location information and status information about objects in the freight terminal.

12. The method of claim 11 wherein the location information is comprised of information derived from at least one of: a global positioning system (GPS), RTLS, an inertial navigation system, and the last completed move.

13. The method of claim 1 wherein updating and re-displaying the 3-D rendering of the freight terminal comprises updating and re-displaying the 3-D rendering of the freight terminal according to input from a user.

14. The method of claim 13 wherein input from the user comprises at least one of: input related to the point of view of the rendering, input related to the zoom level, input related to an object selected from within the rendering, input related to toggling the display of a pre-determined group of objects in the freight terminal, and input designed to filter and/or highlight objects according to user-defined criteria.

15. The method of claim 14 wherein the pre-determined group of objects in the freight terminal comprise at least one of: all containers without scheduled moves, all containers in a particular row in the yard, all active containers, all inactive containers, light posts, buildings, walkways and other fixed objects of the freight terminal.

16. A containerized freight management system comprising:
a model database;
a terminal information database;
data input components;
a display; and
a processing component coupled to the model database, the terminal information database, the data input components and the display, the processing component configured to:
render a 3-D view on the display of a freight terminal and objects within the freight terminal based on 3-D model information contained in the model database and that reflects the location of the objects based on information in the terminal information database;
accept input from the data input components; and
update and re-render the 3-D view on the display in response to the input and to changes in the terminal information database.

17. The system of claim 16 wherein objects within the freight terminal comprise at least one of: freight yards, containers, stacks of containers, rows of containers, berths, vessels, trains, shipping trucks, container handling equipment, buildings, light poles, and other fixed objects of the freight terminal.

18. The system of claim 17 wherein changes in the terminal information database comprise changes that include at least one of status and location information about the objects within the freight terminal.

19. The system of claim 18 wherein the location information is comprised of information derived from at least one of: a global positioning system (GPS), RTLS, an inertial navigation system, and the last completed move.

20. The system of claim 17 wherein trains comprise one or more rail cars equipped to receive and transport containers.

21. The system of claim 17 wherein container handling equipment comprises at least one of: ship-to-shore cranes, quay cranes, straddle carriers, rail-mounted gantry cranes, rubber-tired gantry cranes, side-picks, top-picks, forklifts, hustlers and chassis.

22. The system of claim 16 wherein the processing component is further configured to permit creating a report based on information in the terminal information database.

23. The system of claim 22 wherein the report is related to at least one of the following: the location of one or more containers based on search criteria, the location of one or more pieces of equipment in the freight terminal, and an estimate of the time remaining to complete a task or set of tasks.

24. The system of claim 23 wherein search criteria comprises information related to at least one of: the inclusion of the one or more containers in a queue of containers to be moved, the physical proximity of the one or more containers to a predetermined location, and the destination location of the one or more containers.

25. The system of claim 24 wherein a queue of containers to be moved comprises a queue of containers to be moved that are grouped according to at least one of: moving equipment assigned to move the containers, the destination location of the containers to be moved, the source location of the containers to be moved, and the type of container movements to be performed.

26. The system of claim 25 wherein the type of container movements to be performed comprises of at least one of: a yard-to-yard container move, a yard-to-vessel container move, a vessel-to-yard container move, a yard-to-train container move, a train-to-yard container move, a truck-to-yard container move, and a yard-to-truck container move.

27. The system of claim 25 wherein the destination location of the containers to be moved comprises at least one of: a freight yard, a vessel, a train and a truck.

28. The system of claim 25 wherein the source location of the containers to be moved comprises at least one of: a freight yard, a vessel, a train and a truck.

29. The method of claim 16 wherein input comprises at least one of: input related to the point of view of the rendering, input related to the zoom level, input related to an object selected from within the rendering, input related to toggling the display of a pre-determined group of objects in the freight terminal, and input designed to filter and/or highlight objects according to user-defined criteria.

30. The method of claim 29 wherein the pre-determined group of objects in the freight terminal comprise at least one of: all containers without scheduled moves, all containers in a particular row in the yard, all active containers, all inactive containers, light posts, buildings and walkways.
